(19) United States
(12) Patent Application Publication
(10) Pub. No.: US 2003/0004913 A1
(43) Pub. Date: Jan. 2, 2003

(54) Vision-based method and apparatus for detecting an event requiring assistance or documentation

(75) Inventors: Srinivas Gutta, Buchanan, NY (US); Damian M. Lyons, Putnam Valley, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/897,524

(22) Filed: Jul. 2, 2001

(51) Int. Cl. G06F 17/00; G06N 5/02

(52) U.S. Cl. 706/47

(57) ABSTRACT

A method and apparatus are disclosed for monitoring a location using vision-based technologies to recognize predefined assistance-invoking events. One or more image capture devices are focused on a given location. The captured images are processed to identify one or more predefined events and to initiate an appropriate response, such as sending assistance or recording the event for evidentiary purposes. A number of rules define various assistance-invoking events. Each rule contains one or more conditions that must be satisfied and a corresponding action-item that should be performed when the rule is satisfied. At least one of the conditions for each rule identifies a feature that must be detected in an image using vision-based techniques. An event monitoring process is also disclosed that analyzes the captured images to detect one or more assistance-invoking events defined by the event rules.

### FIELD OF THE INVENTION

The present invention relates to computer-vision techniques, and more particularly, to a method and apparatus for detecting events using vision-based recognition techniques.

### BACKGROUND OF THE INVENTION

Due to increasing labor costs, as well as an inadequate number of qualified employee candidates, many retail businesses and other establishments must often operate with an insufficient number of employees. Thus, when there are not enough employees to perform every desired function, the management must prioritize responsibilities to ensure that the most important functions are satisfied, or find an alternate way to perform the function. For example, many retail establishments utilize automated theft detection systems to replace or supplement a security staff.

In addition, many businesses do not have enough employees to adequately monitor an entire store or other location, for example, for security purposes or to determine when a patron may require assistance. Thus, many businesses and other establishments position cameras at various locations to monitor the activities of patrons and employees. While the images generated by the cameras typically allow the various locations to be monitored by one person positioned at a central location, such a system nonetheless requires human monitoring to detect events of interest.

When such an event of interest includes an injury of an employee or patron, the business proprietor may be exposed to liability. It is therefore desirable to archive any associated images associated with the injury-related event for subsequent evidentiary purposes. With a conventional system requiring human monitoring of the images, however, such injury-related events may not be detected or reported at the time of the event, or within a sufficient period of time to ensure that the images are archived.

With an increasing trend towards false claims of “slip and fall” and other injuries, it is particularly beneficial for the business proprietor to record images of an injury-related event for evidentiary purposes.

A need therefore exists for a monitoring system that uses vision-based technologies to automatically recognize events suggesting that an individual may require assistance. A further need exists for an event monitoring system that employs a rule-base to define each event. Yet another need exists for a monitoring system that uses vision-based technologies to recognize predefined events and to record such events for evidentiary purposes.

### SUMMARY OF THE INVENTION

Generally, a method and apparatus are disclosed for monitoring a location using vision-based technologies to recognize predefined events where an individual may require assistance or may involve liability, referred to herein as assistance-invoking events. The disclosed event monitoring system includes one or more image capture devices that are focused on a given location. The captured images are processed by the event monitoring system to identify one or more assistance-invoking events and to initiate an appropriate response, such as sending assistance or recording the event for evidentiary purposes (or both).

According to one aspect of the invention, a number of rules are utilized to define various assistance-invoking events. Each rule contains one or more conditions that must be satisfied in order for the rule to be triggered, and, optionally, a corresponding action-item that should be performed when the rule is satisfied, such as sending assistance or recording the event for evidentiary purposes (or both). At least one condition for each rule identifies a feature that must be detected in an image using vision-based techniques. Upon detection of a predefined event, the corresponding action, if any, is performed by the event monitoring system.

When the identified assistance-invoking event is a patron requiring assistance, for example, the corresponding action item may be automatically sending store personnel or medical assistance, if appropriate. An illustrative event monitoring process is disclosed to illustrate the general concepts of the present invention that analyzes the captured images to detect one or more assistance-invoking events defined by the event rules.

A more complete understanding of the present invention, as well as further features and advantages of the present invention, will be obtained by reference to the following detailed description and drawings.

### BRIEF DESCRIPTION OF THE DRAWINGS

FIG. 1 illustrates an event monitoring system in accordance with the present invention;

FIG. 2 illustrates a sample table from the event database of FIG. 1;

FIG. 3 is a flow chart describing an exemplary event monitoring process embodying principles of the present invention; and

FIG. 4 is a flow chart describing an exemplary slip and fall detection process incorporating features of the present invention.

### DETAILED DESCRIPTION

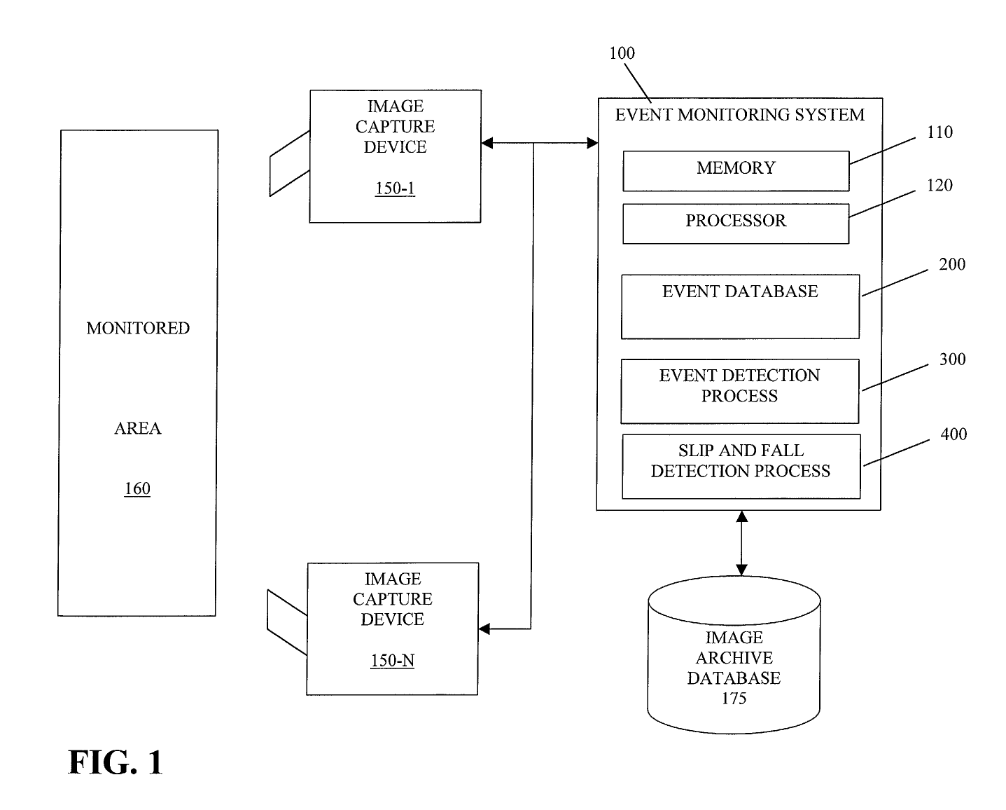

FIG. 1 illustrates an event monitoring system 100 in accordance with the present invention. Generally, the events detected by the present invention are those events involving individuals that may require assistance or events involving liability, hereinafter collectively referred to as “assistance-invoking events.” As shown in FIG. 1, the event monitoring system 100 includes one or more image capture devices 150-1 through 150-N (hereinafter, collectively referred to as image capture devices 150) that are focused on one or more monitored areas 160. The monitored area 160 can be any location that is likely to have an individual requiring assistance, such as an aisle in a store, or to have an event involving potential liability, such as an intersection that may have a significant number of vehicle accidents.

The present invention recognizes that assistance-invoking events are often subsequently involved in litigation. Thus, according to another aspect of the invention, the images captured by the image capture devices 150 may be recorded and stored for evidentiary purposes, for example, in an image archive database 175. As discussed further below, images associated with each detected assistance-invoking event may optionally be recorded in the image archive database 175 for evidentiary purposes. In one embodiment, a predefined number of image frames before and after each detected assistance-invoking event may be recorded in the image archive database 175, together with a timestamp of the event, for example, for evidentiary purposes.

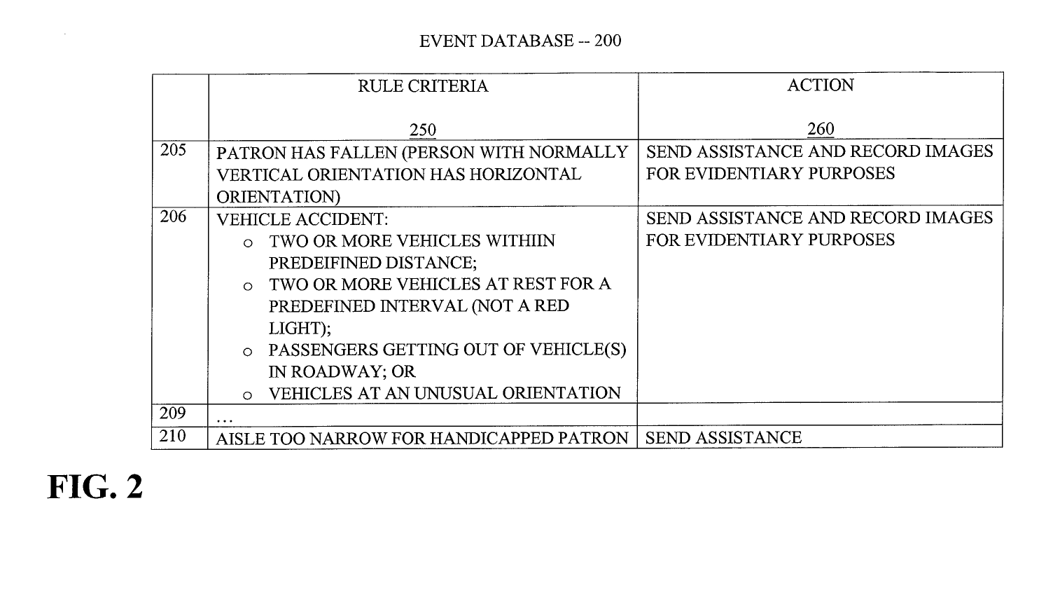

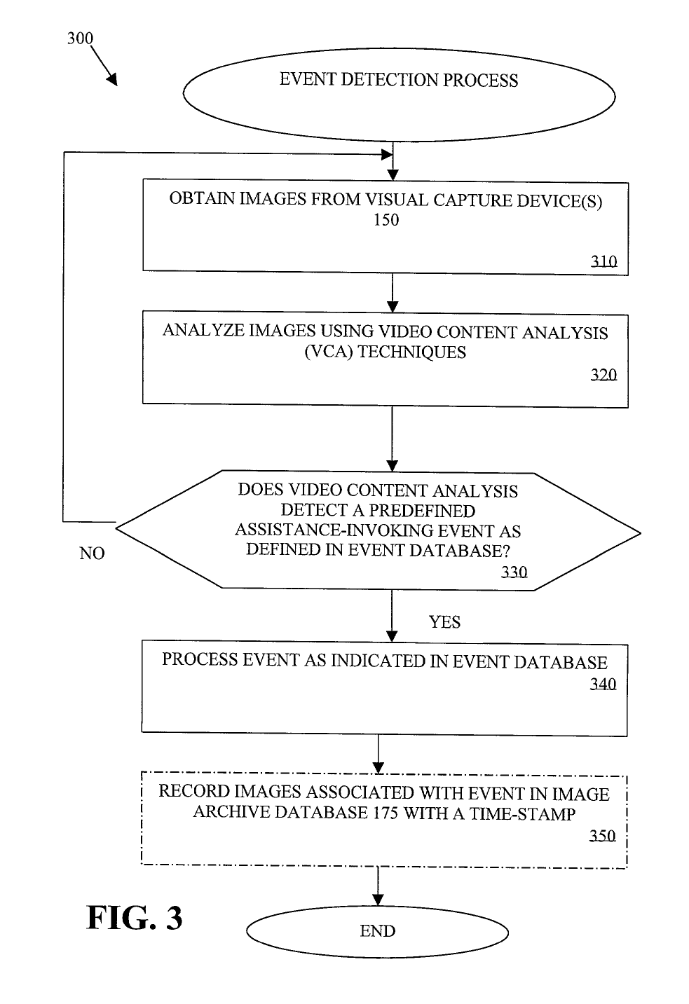

Each image capture device 150 may be embodied, for example, as a fixed or pan-tilt-zoom (PTZ) camera for capturing image or video information. The images generated by the image capture devices 150 are processed by the event monitoring system 100, in a manner discussed below in conjunction with FIG. 3, to identify one or more predefined assistance-invoking events. In one implementation, the present invention employs an event database 200, discussed further below in conjunction with FIG. 2, that records a number of rules defining various assistance-invoking events.

The assistance-invoking events defined by each rule may be detected by the event monitoring system 100 in accordance with the present invention. As discussed further below, each rule contains one or more criteria that must be satisfied in order for the rule to be triggered, and, optionally, a corresponding action-item that should be performed when the predefined criteria for initiating the rule is satisfied. At least one of the criteria for each rule is a condition detected in an image using -vision-based techniques, in accordance with the present invention. Upon detection of such a predefined traffic event, the corresponding action, if any, is performed by the event monitoring system 100, such as sending assistance or recording the event for evidentiary purposes.

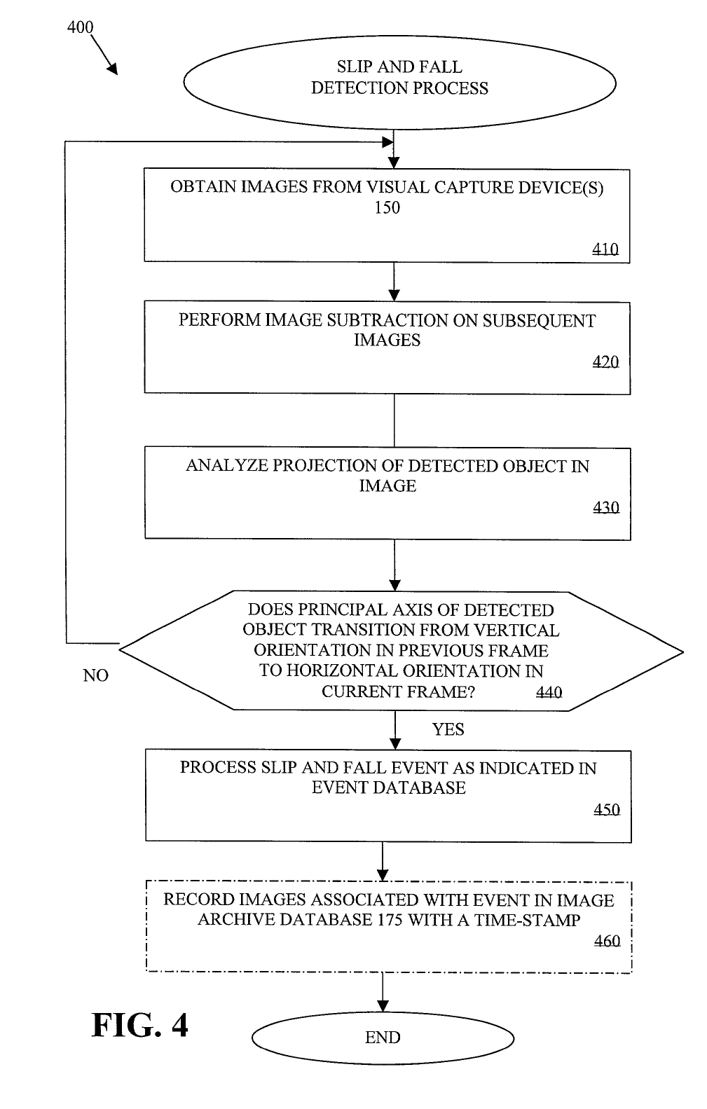

As shown in FIG. 1, and discussed further below in conjunction with FIGS. 3 and 4, the event monitoring system 100 also contains an event detection process 300 and a slip and fall detection process 400. Generally, the event detection process 300 analyzes the images obtained by the image capture devices 150 and detects a number of specific, yet exemplary, assistance-invoking events defined in the traffic event database 200. The slip and fall detection process 400 analyzes the images obtained by the image capture devices 150 and detects when a person has fallen.

The event monitoring system 100 may be embodied as any computing device, such as a personal computer or workstation, that contains a processor 120, such as a central processing unit (CPU), and memory 110, such as RAM and/or ROM. In an alternate implementation, the image processing system 100 may be embodied using an application specific integrated circuit (ASIC).

FIG. 2 illustrates an exemplary table of the event database 200 that records each of the rules that define various assistance-invoking events. Each rule in the event database 200 includes predefined criteria specifying the conditions under which the rule should be initiated, and, optionally, a corresponding action item that should be triggered when the criteria associated with the rule is satisfied. Typically, the action item defines one or more appropriate step(s) that should be performed when the rule is triggered, such as sending assistance or recording the event for evidentiary purposes (or both).

As shown in FIG. 2, the exemplary event database 200 maintains a plurality of records, such as records 205-210, each associated with a different rule. For each rule, the event database 200 identifies the rule criteria in field 250 and the corresponding action item, if any, in field 260. For example, the rule recorded in record 206 is an event corresponding to a vehicle accident. As indicated in field 250, the rule in record 206 is triggered when two vehicles collide. The rule in record 206 specifies a number of independent conditions that may be detected to initiate the rule. For example, when two vehicles are within a predefined distance of one another, an accident has likely occurred. As indicated in field 260, the corresponding action consists of sending assistance to the monitored location 160 and recording the event for evidentiary purposes.

FIG. 3 is a flow chart describing an exemplary event detection process 300. The event detection process 300 analyzes images obtained from the image capture devices 150 and detects a number of specific, yet exemplary, assistance-invoking events defined in the event database 200. As shown in FIG. 3, the event detection process 300 initially obtains one or more images of the monitored area 160 from the image capture devices 150 during step 310.

Thereafter, the images are analyzed during step 320 using video content analysis (VCA) techniques. For a detailed discussion of suitable VCA techniques, see, for example, Nathanael Rota and Monique Thonnat, “Video Sequence Interpretation for Visual Surveillance,” in Proc. of the 3d IEEE Int'l Workshop on Visual Surveillance, 59-67, Dublin, Ireland (Jul. 1, 2000), and Jonathan Owens and Andrew Hunter, “Application of the Self-Organizing Map to Trajectory Classification,’ in Proc. of the 3d IEEE Int'l Workshop on Visual Surveillance, 77-83, Dublin, Ireland (Jul. 1, 2000), incorporated by reference herein. Generally, the VCA techniques are employed to recognize various features in the images obtained by the image capture devices 150.

A test is performed during step 330 to determine if the video content analysis detects a predefined event, as defined in the event database 200. If it is determined during step 330 that the video content analysis does not detect a predefined event, then program control returns to step 310 to continue monitoring the location(s) 160 in the manner discussed above.

If, however, it is determined during step 330 that the video content analysis detects a predefined event, then the event is processed during step 340 as indicated in field 260 of the event database 200. As previously indicated, according to one aspect of the invention, the images associated with a detected assistance-invoking event may optionally be recorded in the image archive database 175, with a time-stamp for evidentiary purposes during step 350. Program control then terminates (or returns to step 310 and continues monitoring location(s) 160 in the manner discussed above).

As previously indicated, the slip and fall detection process 400 analyzes the images obtained by the image capture devices 150 and detects when a person has fallen. As shown in FIG. 4, the slip and fall detection process 400 initially obtains one or more images of the monitored area 160 from the image capture devices 150 during step 410.

Thereafter, subsequent image frames are subtracted during step 420 to detect moving objects. It is noted that in the controlled environment of most retail locations, it can be assumed that a detected moving object is a person. However, well-known human classification techniques can optionally be employed for additional safeguards, if desired, as would be apparent to a person of ordinary skill in the art. The projection of each detected object is analyzed during step 430 to identify the orientation of the object's principal axis (vertical or horizontal).

A test is performed during step 440 to determine if the principal axis of a detected object has transitioned from a vertical orientation in a previous frame to a horizontal orientation in the current frame, suggesting that someone has fallen. If it is determined during step 440 that the principal axis of a detected object has not transitioned from a vertical orientation to a horizontal orientation, then a slip and fall has not occurred and program control returns to step 410 to continue monitoring the location(s) 160 in the manner discussed above.

If, however, it is determined during step 440 that the principal axis of a detected object has transitioned from a vertical orientation to a horizontal orientation, then a slip and fall has occurred and the detected slip and fall event is processed during step 450 as indicated in field 260 of the event database 200. As previously indicated, according to one aspect of the invention, the images associated with a detected assistance-invoking event, such as a slip and fall, may optionally be recorded in the image archive database 175, with a time-stamp for evidentiary purposes during step 460. Program control then terminates (or returns to step 410 and continues monitoring location(s) 160 in the manner discussed above).

It is to be understood that the embodiments and variations shown and described herein are merely illustrative of the principles of this invention and that various modifications may be implemented by those skilled in the art without departing from the scope and spirit of the invention.

What is claimed is:

1. A method for detecting an assistance-invoking event at a monitored location, comprising:
establishing a rule defining said assistance-invoking event, said rule including at least one condition;
processing at least one image of said monitored location to identify said condition; and
providing assistance if said rule is satisfied.

2. The method of claim 1, further comprising the step of recording said at least one image if said rule is satisfied.

3. The method of claim 1, wherein said assistance-invoking event is an injury at said monitored location.

4. The method of claim 1, wherein said assistance-invoking event is an accident at said monitored location.

5. The method of claim 1, wherein said assistance-invoking event is a patron in need of assistance.

6. A method for detecting an assistance-invoking event, comprising:
obtaining at least one image of a monitored location;
analyzing said image using video content analysis techniques to identify at least one predefined feature in said image associated with said assistance-invoking event; and
providing assistance if said predefined feature is recognized in one of said images.

7. The method of claim 6, further comprising the step of recording said at least one image if said predefined feature is recognized in one of said images.

8. The method of claim 6, wherein said assistance-invoking event is an injury at said monitored location.

9. The method of claim 6, wherein said assistance-invoking event is an accident at said monitored location.

10. The method of claim 6, wherein said assistance-invoking event is a patron in need of assistance.

11. A method for documenting an event that may be involved in litigation, comprising:
obtaining at least one image of a monitored location;
analyzing said image using video content analysis techniques to identify at least one predefined feature in said image associated with said event; and
recording said at least one image if said predefined feature is recognized in one of said images.

12. The method of claim 1, wherein said event is an injury at said monitored location.

13. The method of claim 11, wherein said event is an accident at said monitored location.

14. A system for detecting an assistance-invoking event, comprising:
a memory that stores computer-readable code; and
a processor operatively coupled to said memory, said processor configured to implement said computer-readable code, said computer-readable code configured to:
obtain at least one image of a monitored location;
analyze said image using video content analysis techniques to identify at least one predefined feature in said image associated with said assistance-invoking event; and
provide assistance if said predefined feature is recognized in one of said images.

15. The system of claim 14, wherein said feature is recorded in a rule defining said assistance-invoking event.

16. The system of claim 14, wherein said processor is further configured to record said at least one image if said predefined feature is recognized in one of said images.

17. The system of claim 14, wherein said assistance-invoking event is an injury at said monitored location.

18. The system of claim 14, wherein said assistance-invoking event is an accident at said monitored location.

19. The system of claim 14, wherein said assistance-invoking event is a patron in need of assistance.

20. A system for documenting an event that may be involved in litigation, comprising:
a memory that stores computer-readable code; and
a processor operatively coupled to said memory, said processor configured to implement said computer-readable code, said computer-readable code configured to:
obtain at least one image of a monitored location;
analyze said image using video content analysis techniques to identify at least one predefined feature in said image associated with said event; and
record said at least one image if said predefined feature is recognized in one of said images.

21. The system of claim 20, wherein said feature is recorded in a rule defining said assistance-invoking event.

22. The system of claim 20, wherein said event is an injury at said monitored location.

23. The system of claim 20, wherein said event is an accident at said monitored location.

24. An article of manufacture for detecting an assistance-invoking event, comprising:
a computer readable medium having computer readable code means embodied thereon, said computer readable program code means comprising:
a step to obtain at least one image of a monitored location;
a step to analyze said image using video content analysis techniques to identify at least one predefined feature in said image associated with said assistance-invoking event; and
a step to provide assistance if said predefined feature is recognized in one of said images.

25. An article of manufacture for documenting an event that may be involved in litigation, comprising:
a computer readable medium having computer readable code means embodied thereon, said computer readable program code means comprising:
a step to obtain at least one image of a monitored location;
a step to analyze said image using video content analysis techniques to identify at least one predefined feature in said image associated with said event; and
a step to record said at least one image if said predefined feature is recognized in one of said images.
